(19) United States
(12) Patent Application Publication
(10) Pub. No.: US 2012/0010999 A1
(43) Pub. Date: Jan. 12, 2012

(54) PAPERLESS INTERNET BASED ADVERTISING SYSTEM AND METHOD OF USE

(75) Inventor: John S. Feuling, Des Moines, IA (US)

(73) Assignee: FOURTH GENERATION MARKETING, INC., New Hampton, IA (US)

(21) Appl. No.: 13/177,666

(22) Filed: Jul. 7, 2011

Related U.S. Application Data
(60) Provisional application No. 61/362,786, filed on Jul. 9, 2010.

(51) Int. Cl. G06Q 30/00

(52) U.S. Cl. 705/14.58

(57) ABSTRACT

A system and method for advertising. The system includes a website that is accessible over an electronic network. The website allows an administrator or advertiser to enter existing advertisements or new advertisements into a database. The advertiser enters information related to the advertiser and the advertisement into the database. The advertisements are presented to consumers through a website or an application on a mobile device. Advertisements are presented to the consumer based on various parameters such as geographic location in proximity to the consumer. In this manner, an advertiser can more easily provide real-time location-based advertising services to target local customers.

### CROSS REFERENCE TO RELATED APPLICATION

This application claims the benefit of U.S. Provisional Application No. 61/362,786 filed Jul. 9, 2010.

### BACKGROUND OF THE INVENTION

This invention is directed toward a system for advertising. More specifically, and without limitation, this invention relates to an internet based advertising platform.

Conventional print advertising in newspapers, magazines and other periodicals is well known in the art. To utilize this type of advertisement, an advertiser would place a type-written or picture based advertisement with a periodical. The advertisement is then printed in the periodical which is distributed to the subscribers and consumers of the periodical. While effective, this form of advertising has its disadvantages. Particularly, advertising in periodicals is expensive due to manufacturing and delivery costs. In addition, print advertising is inherently limited by space. Furthermore, the affect of the advertisement is limited to the distribution of the periodical and the advertisement is limited to only two-dimensional static picture and text advertisements.

As an alternative to conventional periodical based advertisement, website and internet based advertisements were developed. Specifically, advertisers developed web-based advertisements such as websites, pop-ups, and banner ads that are viewable through the internet. These web based advertisements present advantages over periodical based advertisements. In particular, this form of advertising is not limited to the physical periodical and therefore the physical distribution of the periodical. Also, the web based advertisements are not limited to text and pictures. Although this form of advertising has its benefits over physical periodical based advertisements there are still problems and disadvantages related to this form of advertising. In particular, problems remain regarding advertisers being able to target local customers and make them aware of new, local and digital promotions. Further, problems remain regarding customers being able to sift through the broad internet to locate local businesses. Therefore there exists a need in the art that addresses these problems.

Thus, an objective of the invention is to provide an advertising platform that is less expensive than print advertising.

Another objective of the invention is to provide an advertising system that is not limited to text-based and picture based advertisements.

Yet another object of the invention is to provide an advertising platform that allows advertisers to target local customers.

Another object of the invention is to provide an advertising platform that is more versatile than print advertising.

Yet another object of the invention is to make the internet, and internet advertising, more accessible to a much broader range of people by eliminating the need for knowledge of internet programming.

Another object of the invention is to provide a system is based on standard .pdf, .jpeg and .mov files which easily allows consumer level, user-generated advertising content to be transmitted to cyberspace.

Yet another object of the invention is to provide an advertising system that is environmentally friendly as it does not require printing advertisements.

These and other objects, features or advantages of the invention will become apparent from the specification and claims.

### BRIEF SUMMARY OF THE INVENTION

A system and method for advertising. The system includes a website that is accessible over an electronic network. The website allows an administrator or advertiser to enter existing advertisements or new advertisements into a database. The advertiser enters information related to the advertiser and the advertisement into the database. The advertisements are presented to consumers through a website or an application on a mobile device. Advertisements are presented to the consumer based on various parameters such as geographic location in proximity to the consumer. In this manner, an advertiser can more easily provide real-time location-based advertising services to target local customers.

### BRIEF DESCRIPTION OF THE DRAWING

FIG. 1—is a schematic diagram of an advertising system.

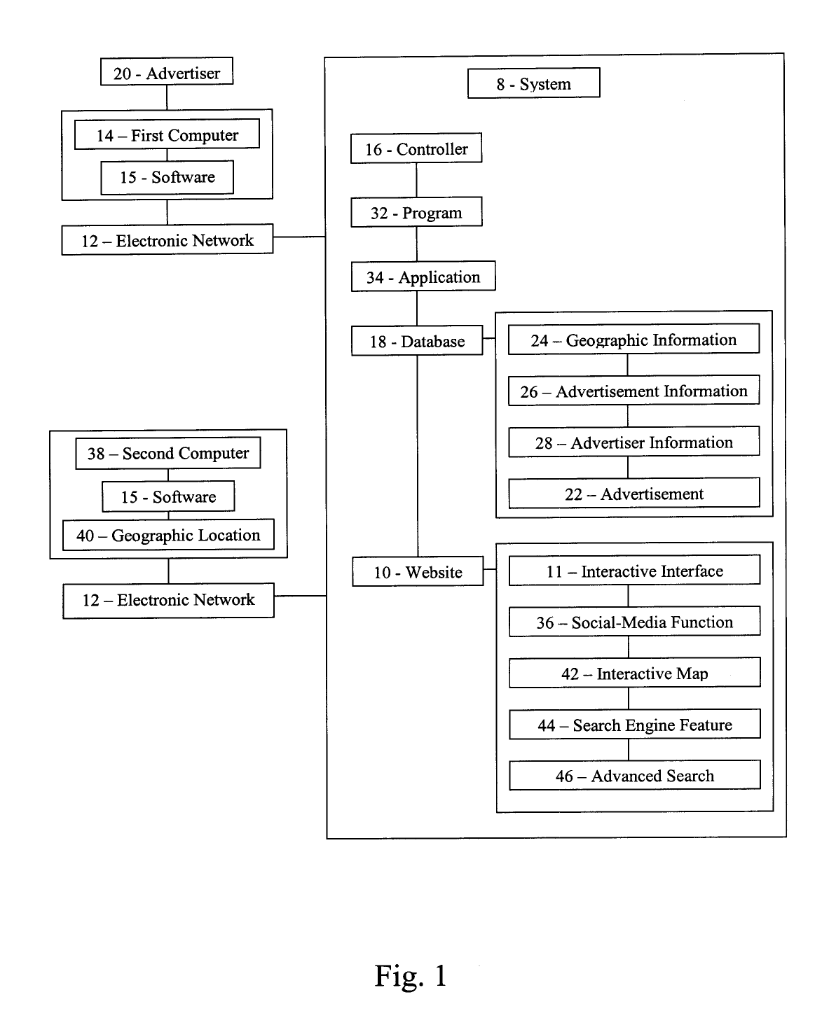

FIG. 2—is an exemplary diagram of the screen layout of the advertising system.

### DETAILED DESCRIPTION OF THE PREFERRED EMBODIMENT

With respect to the figures, the system 8 and method include a website 10 that is accessible over an electronic network 12 through a first computer 14, computing device, mobile device or other internet enabled electronic device having software 15. In no way is the term “computer” to be construed in a narrow manner, the term computer herein means any computing device which is capable of accessing, processing and displaying electronic information. The website 10 has an interactive interface 11 and is connected to a controller 16 having a database 18. The database 18 contains content about the advertiser 20 and the advertisement 22 itself including geographic information 24, advertisement information 26, advertiser information 28, the advertisement 22 itself as well as other information.

The database 18 contains geographic information 24 regarding the intended audience for each advertisement 22. The geographic information 24 includes all states, counties, cities, zip codes and other geographic delineations in the United States, and all other countries of the world. Advertisers 20 select which geographic locations their advertisements 22 are to be viewed in, from cities, counties or nation wide, etc.

The database 18 also contains advertisement information 26, or information regarding what the advertisement 22 is about or the target audience for the advertisement. As examples, this advertisement information may include, but is not limited to, the types of products or services the advertisement 22 contains; whether there are any coupons or discounts related to this advertisement 22; the duration of the advertisement 22; when the advertisement was published; whether the advertisement 22 is new; whether the advertisement 22 is for a limited time; whether the advertisement 22 contains any interactive features such as links, attachments or videos or the like; the intended age group for the advertisement 22; key words or search terms for the advertisement 22; beginning and ending dates for the advertisement 22; or any other information related to the advertisement 22 that may help the consumer find the advertisement 22 or information the advertiser 20 deems important to the advertisement 22.

The database 18 also contains advertiser information 28, an advertiser profile 28, or information related to the advertiser 20 themselves. As examples, advertiser information may include, but is not limited to, the location(s) of the advertiser 20; how long the advertiser 20 has been in business; what products or services the advertiser 20 offers; what organizations the advertiser 20 is a part of such as the Better Business Bureau; a consumer quality or satisfaction ranking of the advertiser or consumer feedback; the days or hours of operation; the current queue, capacity, availability or wait-time for the advertisers goods/services; an open/closed indicator; whether the advertiser 20 accepts or is open to reservations; a menu of product or service offerings; a list of current specials or coupons; or any other information related to the advertiser 20 that the advertiser 20 deems important. The database also contains social-media tie-in information, which will be discussed further below.

The database 18 also includes the advertisement 22 itself. An advertiser 20 can either upload an existing advertisement 22 into the system or develop a new advertisement 22 through the system.

Should the advertiser 20 desire to upload an existing advertisement 22 into the system 8, the user uploads or enters an advertisement 22 in any form to the system 8. These existing advertisements 22 may include two-dimensional format such as a newspaper or magazine “box” advertisement; multimedia advertisements such as TV ads or movie trailers; interactive web or Internet based advertisements; a blend of any of these advertisements; or any other form of advertisement.

Alternatively, should the advertiser 20 desire to develop a new advertisement 22, the advertiser 20 accesses an ad-editor 30 feature which allows the user to upload existing pictures, text, videos or any other information into the system 8. The ad-editor 30 feature also allows the advertiser 20 to design new graphic elements for the advertisement 22. The ad-editor 30 feature then allows the advertiser 20 to combine the existing uploaded elements with the newly developed elements to produce and publish a new advertisement 22 completely within the system 8.

Once the advertisement 22 is entered into the database 18, or developed through the ad-editor feature the software or an administrator controlling the system 8, removes the coding out of the advertisement 22 itself and places the advertisement 22 into one of three industry-standard native file-types: (1) .jpeg, the standard digital image file type, used for any picture, (2) .pdf, the Adobe Portable Document Format for any document, which preserves fonts and images for accurate display on any computer, and (3) .mov for any digital video taken on a camera or phone or other recording device. The advertisement 22 is accepted in its unaltered form from its traditional media placement. As such, there is no conversion or formal reformatting to get the advertisement 22 on the web as the program 32 automatically places the advertisement 22 into one of the three above stated industry-standard native file-types thereby saving time and money and improving the ease of advertising. Other similarly used file-types are hereby contemplated for use through this system 8.

Once the advertiser 20 enters the geographic information 24, the advertisement information 26, advertiser information 28, and the advertisement 22 itself, based on various factors the program 32 calculates a price for the advertisement 22. The factors the program 32 may consider in calculating a price may include, but are not limited to: the geographic scope of the advertisement 22, the type and amount of content contained in the advertisement 22, the beginning and ending dates for the advertisement 22, whether this advertiser 20 receives any preferential treatment or discounts, and any other combination of information contained in the database 18 or entered into the system 8. Once the price is calculated for the advertisement 22 the advertiser 20 submits payment and/or payment information through the system 8, website, mobile device, or any other access point for pre-payment. Alternatively, the advertiser 20 is billed for their advertisement 22 which can be added to an external account, or added to their account generated within the system 8.

The system 8 has at least two redundant delivery points for the advertisements 22 in the database 18, a website 10 and a downloadable application 34 for mobile devices such as the Apple iPhone and the iPad. The database 18 will serve both delivery points.

Advertisers 20 include newspapers, magazines, other periodicals, companies, organizations, TV stations, radio stations, advertisement agencies, websites, blogs, individuals or any other person or group desirous of placing and publishing an interactive multimedia advertisement. Advertisements 22 can be one-time-only events or automatic and reoccurring events based on a subscription model, where for example, a newspaper subscribes to publish all of their print ads through the system 8.

The system 8 also has various social-media functions 36 and tie-ins. The social-media information 36 allows an advertiser 20 or advertisement 22 to connect the advertiser 20 or particular advertisements 22 with an established social-media system such as Facebook, MySpace, Twitter, blogs or the like. Alternatively, a similar online identity can be created through the system 8 to represent a particular advertiser 20 or advertisement 22. This allows the advertiser 20 to maintain contact with customers and potential customers, provide information regarding the advertiser and advertisements, send updates, coupons and other information to customers and potential customers, receive information from customers and potential customers, develop on-line relationships with customers and other customers, as well as achieve any other functionality or purposes served by other similar social-media sites such as Facebook, My Space, Twitter, blogs, or the like.

Similarly, the social-media function 36 also allows a customer or potential customer to link their own existing social-media identities or accounts, such as Facebook, My Space, Twitter, blogs or the like, to the system or generate a new social-media identity wholly within the system, free of charge. This allows a customer to establish relationships with advertisers 20 or advertisements 22 as well as other customers, save or bookmark particular advertisers 20 or advertisements 22 for quick reference, subscribe to particular advertiser's or advertisement's publications, posts, coupons or any other information the advertiser 20 or advertisement 22 distributes. The social media function 36 also allows customers and potential customers to become a “fan” or “follower” of particular advertisers 20 or advertisements 22, subscribe or receive information, coupons, promotions, or benefits accordingly. The social-media function 36 also allows customers to rate products, services, advertisers, advertisements, coupons, etc. as well as provide feedback to the advertisers themselves as well as other customers and review the ratings and feedback provided by other customers or advertisers 20. The social-media function 36 also allows the customers to share their likes and dislikes and other interests and information they are amenable to with fellow customers or advertisers 20.

With respect to the social-media functionality 36, there are a myriad of choices that allow consumers and advertisers 20 to share as little or as much information through the system as they choose. This allows a user to be as involved or as un-involved in the social-media aspect of the system as they desire to be.

In operation, an advertiser 20 accesses the system 8 through the website 10 over an electronic network 12. Through the interactive interface, the advertiser 20 enters the geographic information 24, or the geographic locations where the advertiser wants the advertisement 22 to be viewed. Next, the advertiser enters the advertisement information 26, or important information related to the advertisement. Next, the advertiser 20 enters the advertiser information 28, or important information about the advertiser 20 itself. Next, the advertiser 20 either uploads an existing advertisement or develops a new advertisement through the ad-editor feature 30 by uploading pictures, text and movies and developing graphic features and combining these elements into an advertisement 22. Once the advertisement 22 is complete, the program 32 and/or the administrator controlling the program converts the design or production, by removing the underlying coding out of the advertisement 22 (e.g. this is essentially the functionality of the internal .pdf generator—Adobe refers to this process as “distilling”), and places the advertisement 22 into one of three industry-standard native file-types (1) .jpeg, (2) .pdf, and (3) .mov. The advertisement 22 is then generated in a form that is unaltered from its audio and visual design. The program 32 calculates a price for publishing the advertisement 22 based on the various information entered. Once the price is calculated the advertiser 20 remits payment or payment information through the system, website, mobile device or any other access point. Once payment is accepted the advertisement 22 is published. Alternatively, credit is extended and the user is billed for their advertisement 22 either through the system or through an external system.

A consumer accesses the advertisements through a second computer 38 by visiting the website 10 over an electronic network 12. The consumer is prompted to enter or select their geographic location 40. This can be achieved through clicking on or interfacing with an interactive map 42 by selecting their location. Alternatively, the program 32 automatically detects the geographic location 40 of the consumer through electronic information transmitted through the electronic network 12, such as the IP address of the consumer's computer or the GPS location of the consumer's computer or mobile device. Alternatively, a consumer downloads the application 34 to their mobile device which displays advertisements 22 based on the mobile device's geographic location 40 and user entered display criteria. To view or receive advertisements 22, the consumer opens the application 34. When the application 34 is opened the system detects the geographic location 40 of the mobile device. Once the geographic location 40 of the consumer is known, relevant advertisements 22 are presented to the consumer.

Alternatively, the consumer searches for advertisements 22 related to a particular topic, location or search criteria. This is done through the use of a search engine feature 44, such as a Google™ search box which searches the database for the closest match to the search criteria. Alternatively an advanced search function 46 is presented wherein a plurality of search boxes are presented for predetermined criteria such as the type of business the consumer is looking for, the hours of operation, the distance from the consumer or geographic location of the advertiser, whether the advertiser 20 is currently open, or any other category of information identified herein. The consumer then enters a plurality of search criteria into these specified search criteria boxes 44. In this event, the consumer enters search terms into a search function 44 or selects search criteria from a search interface. Once search parameters are selected, the program 32 presents advertisements 22 that most-closely match those parameters to the consumer through the website 10 interface.

When an advertisement 22 is presented to the consumer, the consumer can view the advertisement 22, navigate through any interactive links on the advertisement 22, watch any animations, videos or movies attached thereto, download any attachments, print or save any coupons or manipulate the advertisement 22 in any possible way, make reservations, contact the advertiser 20, forward the advertisement 22 to friends, link to the advertisement 22, or use the advertisement 22 in any other way. In addition, the consumer can select a navigation button on the advertisement 22 wherein the consumer's computer 38 directs the consumer directly to the advertiser through a GPS navigation feature.

Once the consumer is finished with the present advertisement 22, the consumer navigates to the next advertisement 22 within the system. This process repeats until the consumer has finished reviewing advertisements 22.

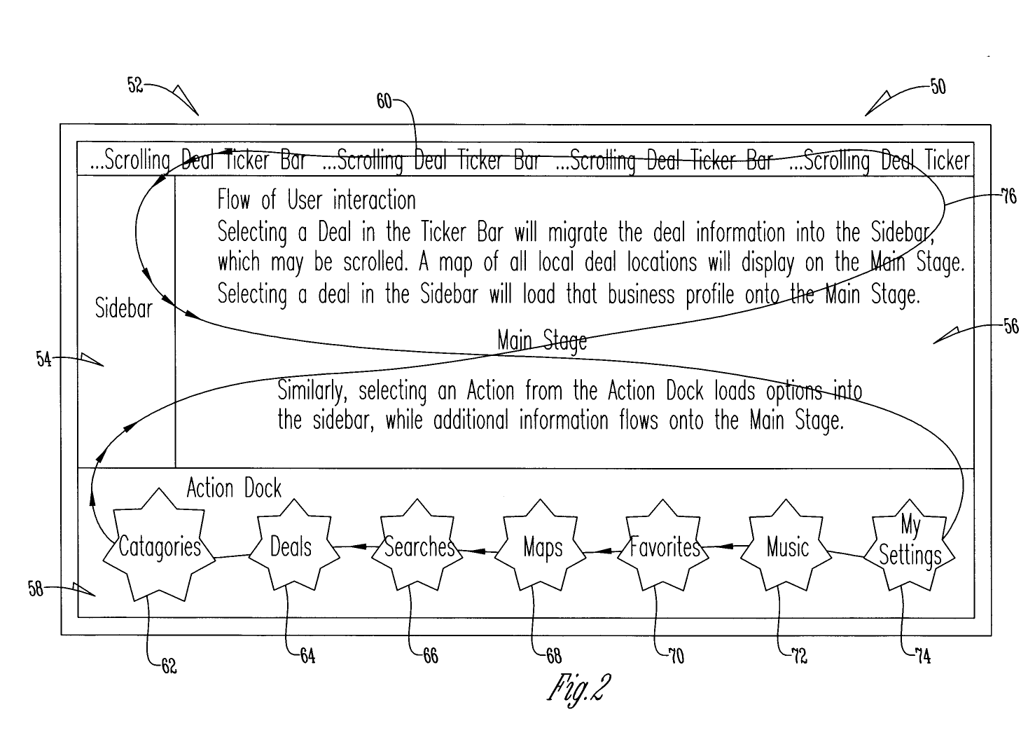

With respect to FIG. 2 an exemplary diagram of the screen layout 50 of the website 10 or application 34 of the advertising system 8 is presented. FIG. 2 is merely an exemplary embodiment of various features. These various features can be combined in any way and in any form to accomplish the goals and objectives of the invention. Presented in this exemplary embodiment is a ticker bar 52, a side bar 54, a main stage 56 and an action dock 58. While the screen layout 50 only displays one of each of these features, the screen layout 50 is not so limited, and instead the screen layout 50 is customizable to include a plurality of each of these features 52, 54, 56, 58, such as two ticker bars 52 or two side bars 54, so as to better meet the user's needs.

Preferably at least one ticker bar 52 resides at the top of the screen layout 50. Ticker bar 52 scrolls short interactive messages, such as an attention grabbing 5-word headline 60 regarding certain topics. The administrator of the website 10 can control the information displayed in the ticker bar 52, such as only presenting information regarding local deals or local events. Alternatively, the user can customize the ticker bar 52 to present specific information such as local deals, local events, music events, local restaurants, local attractions, local news, instant messages from social media friends or organizations, or any other category of information. Alternatively, the user can add plurality of ticker bars 52, each of which is dedicated to a single category of information. As an additional feature, as each headline 60 is scrolling across the ticker bar 52, additional information such as text, pictures, videos, maps, coupons, or the like is displayed in the sidebar 54.

If the user sees a headline 60 in the ticker bar 52, or additional information in the sidebar 54 related to that headline 60 that is of particular interest the user clicks on the headline 60 in the ticker bar 52 or the additional information in the sidebar 54 which opens the full advertisement 22 in the main stage 56 of the screen layout 50. Once opened in the main stage 56, the user can interact with all the features of the full advertisement 22 in the main stage, as is described herein. The sidebar 54 is preferably displayed the length of the screen layout 50 along one side of the screen. The sidebar 54 is interactive and can be scrolled

Alternatively, instead of opening the headline 60 or advertisement 22 in the main stage 56, the user can drag-and-drop the headline 60 or additional information in the sidebar 54 into a basket or folder in either the sidebar 54 or the action dock 58 so as to save the headline 60 or advertisement 22 for later review. This process is similar to bookmarking the headline 60 or adding the headline 60 to the user's favorites folder.

Alternatively, selecting a headline 60 in the ticker bar 52 migrates the headline 60 into the sidebar 54 with all other selected headlines 60, which can be scrolled. Sidebar 54 also contains a function wherein selected headlines 60 can be organized into a folder system so as to allow the user to place like headlines 60 together and more easily navigate through their selected headlines 60. A map of all local deal locations, or a map of the location of all headlines 60 placed in the sidebar 54 is displayed in the main stage 56. Selecting a headline 60 in the sidebar 54 or selecting a local deal location in the map on the main stage will load additional information regarding that deal or that businesses profile in the main stage 56.

Presented in the action dock 58 is a plurality of categories 62. Each category 62 acts as an interactive folder and stores particular information such as headlines 60, local deals 64, searches 66, maps 68, favorites 70, music 72, settings 74, or any other category of information. Selecting a category 62 in the action dock 58, such as headlines 60, local deals 64, searches 66, maps 68, favorites 70, music 72, settings 74, acts to toggle or switch the ticker bar 52, sidebar 54 and main stage 56 to display information related to the selected category 62. In this way the user can specifically control the information displayed. For instance, if the user is only interested in finding deals 54, the user selects the deals 64 category 62 and the system 8 will display only that information. If the user is interested in deals with 20 miles of the user's current location, the user will enter this information using the system's settings, in this way only deals within the specified distance will be displayed.

Advertisers 20 select the criteria for their advertisements and pay monthly package prices for the opportunity to display their advertisements 22 in this system. The advertisers 20 also select additional interactive features to attach to the advertisements 20 such as hyperlinks, instant messaging, coupon display, videos, audio, mapping, navigation, etc., all of which can be built through the templates in the system 8 and can be charged and paid for as part of or in addition to the base fee or through package deals.

Arrow 76 shows the progression of headlines 60 in the ticker bar 52 transition to the sidebar 54 when selected. Next, selected headlines 60 in the sidebar 54 are displayed in the main stage 56. Arrow 76 also shows how the user can control the headlines 60 displayed in the ticker bar 52 by selecting a category 62 in the action dock 58. In this way an efficient, customizable, interactive, social media driven advertising platform is presented which solves many of the problems in the art.

From the above discussion it will be appreciated that presented is a new and improved paperless Internet based advertising system and method of use. The system and method is less expensive than print based advertising. The system and method is not limited to two-dimensional text and picture based advertisements. The system and method allows advertisers to target local customers and is more versatile than traditional advertisements. The system and method allows advertisers to present vide, animation and interactive advertisements to the consumer

It will be appreciated by those skilled in the art that other various modifications could be made to the device without parting from the spirit and scope of this invention. All such modifications and changes fall within the scope of the claims and are intended to be covered thereby.

What is claimed is:

1. A method of internet advertising comprising the steps of:
providing a first computer having software connected to the internet over an electronic network;
accessing a website having an interactive interface by an advertiser through the first computer wherein the website has a program and a database;
entering geographic information through the website;
submitting an advertisement through the website;
accessing the website through a second computer by a consumer;
displaying the advertisement on the second computer based on the geographic information.

2. The method of claim 1 further comprising the steps of:
entering advertiser information through the website; and
displaying the advertisement on the second computer based on the advertiser information and geographic information.

3. The method of claim 2 further comprising the steps of:
entering advertisement information through the website;
displaying the advertisement on the second computer based on the advertiser information, geographic information and the advertisement information.

4. The method of claim 2 wherein the advertiser information includes the name of the advertiser, the nature of the advertiser's business, the products/services the advertiser offers, days of operation and hours of operation.

5. The method of claim 3 wherein the advertisement information includes the products/services offered, pricing, discounts, duration, and interactive features.

6. The method of claim 1 wherein the geographic information includes the geographic target wherein the advertisement is to be viewed by consumers.

7. The method of claim 1 wherein the geographic information is selected from the group consisting of the country, state, county, city, zip code, or physical distance from a predetermined location.

8. The method of claim 1 wherein consumers within the geographic area are specified by the geographic information.

9. A method of displaying internet advertising based on the geographic location of a potential consumer comprising the steps of:
providing a first computer having software connected to the internet over an electronic network;
accessing a website having an interactive interface by a consumer through the first computer wherein the website has a program and a database;
obtaining the geographic location of the consumer;
searching the database for advertisements that are directed to the geographic location of the consumer;
displaying an advertisement on the first computer based on the geographic location of the consumer.

10. The method of claim 9 further comprising the step of entering additional search criteria into the website.

11. The method of claim 9 further comprising the step of searching the website for specific advertisements through the use of a search function.

12. The method of claim 9 further comprising the step of interacting with interactive features of the advertisement.

13. The method of claim 9 further comprising the step of displaying a video on the advertisement.
